(19) United States
(12) Patent Application Publication
(10) Pub. No.: US 2002/0117520 A1
(43) Pub. Date: Aug. 29, 2002

(54) Portable infant carrier

(76) Inventors: Er-Jui Chen, Kaohsiung Hsien (TW); Tse-Chien Wu, Kaohsiung (TW); Huang-Yi Cheng, Chia-I Hsien (TW)

Correspondence Address: BIRCH STEWART KOLASCH & BIRCH, PO BOX 747, FALLS CHURCH, VA, 22040-0747, US

(21) Appl. No.: 10/083,511

(22) Filed: Feb. 27, 2002

(30) Foreign Application Priority Data
Feb. 27, 2001 (CN) 01205677.4

(51) Int. Cl. A61G 1/00; A61G 5/00

(52) U.S. Cl. 224/158

(57) ABSTRACT

A portable infant carrier includes a basin-shaped base having a mattress pad laid thereon for carrying a baby, and a first plate and second plate pivotally mounted on the base. The first and second plates are selectively movable between a position to cover the base, and a position where the first plate is inclined for the baby to lean on. The mattress pad also serves as a partition under which some baby articles, such as milk bottles or nipples, can be stored.

### BACKGROUND OF THE INVENTION

1. Field of the Invention

The invention generally relates to a portable infant carrier, and particularly relates to a portable infant carrier that includes additional functions of baby swing and storage of baby articles.

2. Related Art

There are now lots of baby-carrying devices in the market. These products, including strollers, infant car-seats, infant carriers, playpens, bassinets, swings, highchairs and walkers, help babies move, play, eat, sleep, learn and so on, and help parents take care of their babies.

A baby-carrying device, such as an infant car-seat, infant carrier or bassinet, usually includes a carrier for carrying a baby. A mattress pad is laid on the carrier to increase comfort for the baby. The baby-carrying device also includes rails for carrying by hand or connecting to a stroller or other supporting member. However, conventional baby carriers are open types with no covers or shields formed on top of the carriers. Of course, when carrying a baby, there is no need to have a cover on the carrier. But when it is being stored, the pad of the carrier when laid open can easily collect dust and germs that may cause skin allergy or illness to the baby.

### SUMMARY OF THE INVENTION

The object of the invention is to provide a portable infant carrier that can be covered when stored in order to prevent dust contamination.

A portable infant carrier according to the invention includes a basin-shaped base having a mattress pad laid thereon for carrying a baby, and a first and second plate pivotally mounted on the base. The first and second plates are selectively movable between a position to cover the base, and a position where the first plate is inclined for the baby to lean on. The mattress pad also serves as a partition under which some baby articles, such as milk bottles or nipples, can be stored.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a perspective view of an infant carrier of the invention with the first and second plates closed;

FIG. 2 is a perspective view of an infant carrier of the invention with the first plate opened and the second plate closed;

FIG. 3 is a perspective view of an infant carrier of the invention with the first plate closed and the second plate opened;

FIG. 4 is a side view of an infant carrier of the invention;

FIG. 5 is an explanatory view showing the usage condition of an infant carrier of the invention being held and carried by a user; and

FIG. 6 is an explanatory view showing the usage condition of an infant carrier of the invention being held and swung by a user.

### DETAILED DESCRIPTION OF THE INVENTION

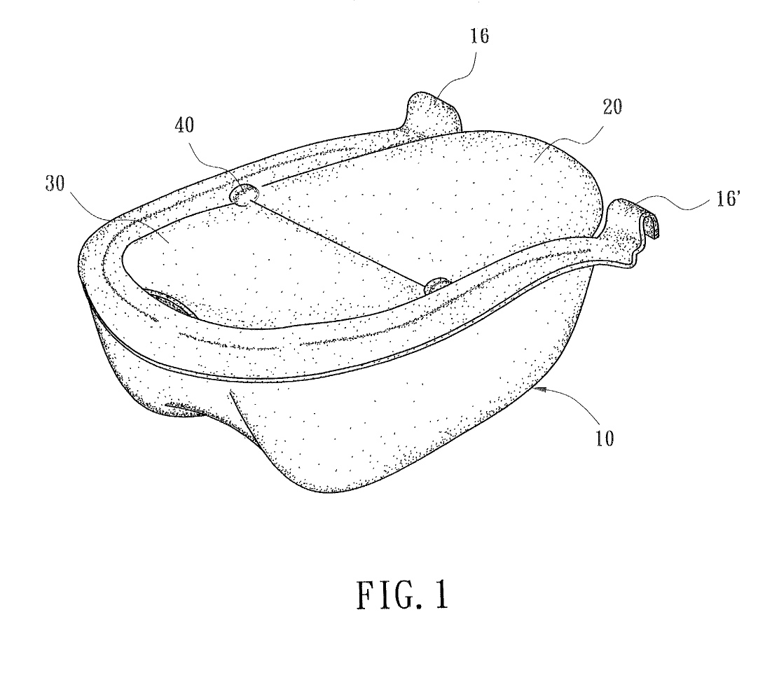

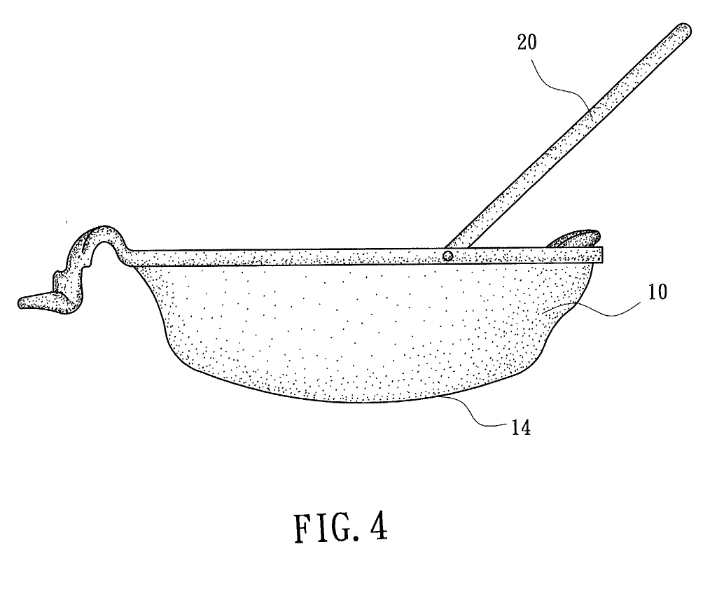

As shown in FIGS. 1 to 4, a portable infant carrier of the invention includes a base 10. The base 10 is a basin-shaped unit having a cavity 11 for carrying a baby or other articles. A mattress pad 12 placed in the cavity is soft and comfortable for a baby to lie on. A handle 13 is formed on one side of the base 10 so that the whole unit can be held and carried by a user. The bottom of the base 10 is curved so that the base is easily rocked by a user when being placed on a surface.

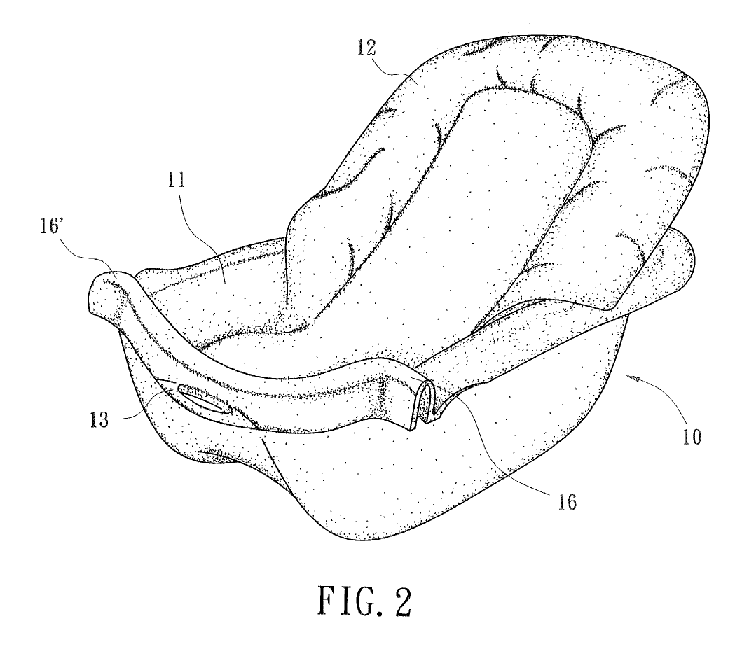

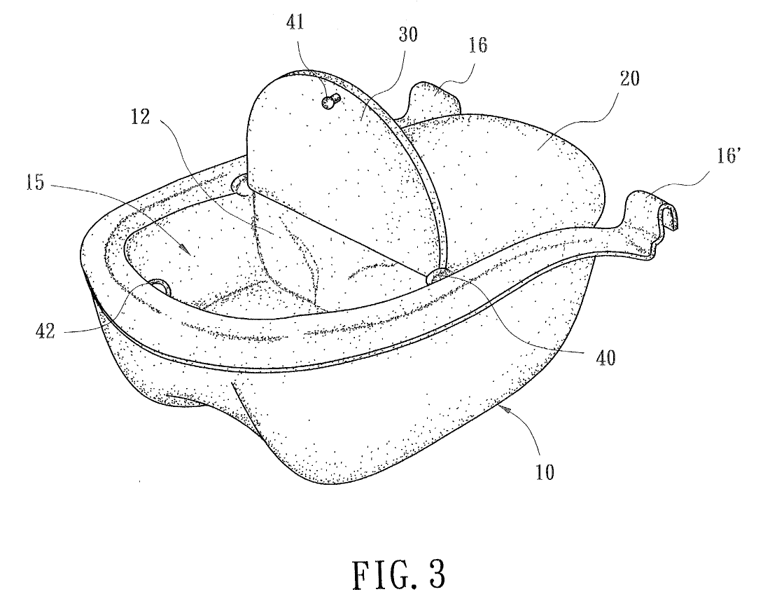

The first plate 20 and second plate 30 are pivotally mounted on the base 10. One end of the first and second plate 20 and 30 is a straight edge and the other end is a curvy edge to fit the shape of the base 10. The straight ends of the first and second plates 20 and 30 are pivoted on a hinge 40 located in the middle upper portion of the base 10 so that the first and second plates 20 and 30 can be selectively moved between a position to cover the base 10 and a position to open the cavity 11. As shown in FIG. 1, when the infant carrier is not used, the first and second plates 20 and 30 can cover the base 10, and the cavity 11 will not be contaminated by dust or germs. One end of the mattress pad 12 covers the surface of the first plate 20. The first plate 20 can be tilted so as to support the baby's back in an upper angle as shown in FIG. 2. The other end of the mattress pad 12 also covers the second plate 30 and forms a storage cavity 15 under the second plate 30. The storage cavity 15 can store baby articles such as milk bottles, nipples or toys. The second plate 30 can be laid down for covering the cavity 15, or opened for access to the articles, as shown in FIG. 3.

In order to fix the first and second plates 20 and 30 to the base 10 when the carrier is not in use, the base 10 is formed with two extrusions 16 and 16′ between which the distance is smaller than the two sides of the first plate 20 so that the first plate 20 can be pressed and clamped by the extrusions 16 and 16′. The second plate 30 is formed with a plug 41 for engaging with a grasping portion 42 formed on the base 10 so that the second plate 30 can be fixed to the base 10 when the second plate 30 covers the base 10.

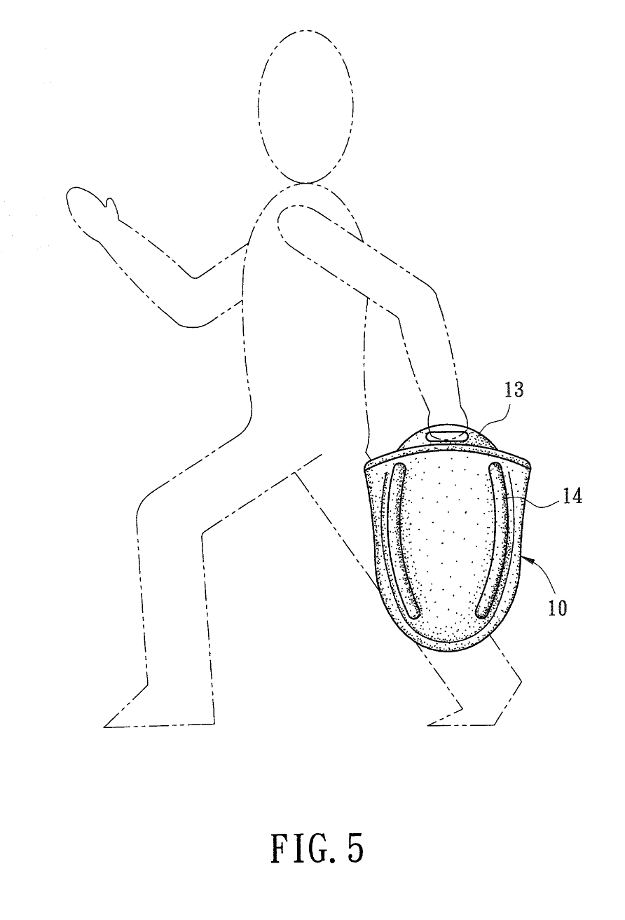

As shown in FIG. 1, when the infant carrier is not in use, the first and second plates 20 and 30 can be laid down to cover the cavity 11 of the base 10 so that dust or germs will not contaminate the interior or the mattress pad 12 of the infant carrier. When carrying the carrier, the user can hold the carrier with the handle 13, as shown in FIG. 5.

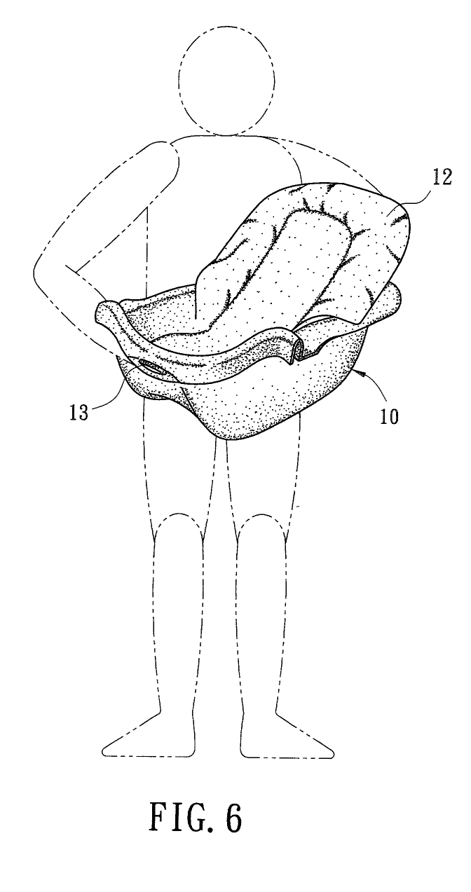

When a baby lies in the carrier, the first plate 20 can be tilted to support the baby's back on the mattress pad 12 with a comfortable angle for the baby. The carrier can be placed on a flat surface and rocked by hand on the curvy bottom 14 of the base 10. Or, the user can hold the base 10 up and rock the baby, as shown in FIG. 6.

As shown in FIG. 3, the mattress pad 12 forms a storage cavity 15 for storing baby articles such as nipples, milk bottles or toys. The user can lift the second plate 30 for access to the articles.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An portable infant carrier comprising:
a base being a basin-shaped and having a curvy bottom for rocking on a surface; and
a first and a second plate, having a hinge on one side to be pivotally mounted on said base for covering said base;
wherein said first plate is movable to a position for supporting said baby's back at a suitable angle.

2. The portable infant carrier according to claim 1 wherein said first and said second plate connected by one end with each other and said hinge is mounted thereon.

3. The portable infant carrier according to claim 1 wherein said base further comprises a handle for carrying.

4. The portable infant carrier according to claim 1 wherein said base comprises a mattress pad laid thereon.

5. The portable infant carrier according to claim 1 further comprising a plug on another side of said first plate and said second plate and a grasping portion formed on the edge of said base, wherein said plug is fastened to said grasping portion to fix said first and second plate on the position covering said base.
